(19) United States
(12) Patent Application Publication
(10) Pub. No.: US 2013/0254009 A1
(43) Pub. Date: Sep. 26, 2013

(54) TRANSACTION INFORMATION INTERFACE

(71) Applicant: Willard A. Barr, Charlotte, NC (US)

(72) Inventor: Willard A. Barr, Charlotte, NC (US)

(73) Assignee: Bank of America, Charlotte, NC (US)

(21) Appl. No.: 13/426,678

(22) Filed: Mar. 22, 2012

(51) Int. Cl. G06Q 30/02; G06Q 20/10

(52) U.S. Cl. 705/14.27

(57) ABSTRACT

Apparatus and/or methods for performing a method for distributing rewards points are presented. Such apparatus and methods may include using a receiver module to receive a data file. The data file may include transaction information representing a customer's transactions that occurred over a predetermined period of time. The receiver module may also be configured to receive transaction processing network identification information and rewards partner identification information. The apparatus and/or methods may be further configured to store, in computer readable memory, (1) the data file; (2) transaction processing network identification information; and (3) the rewards partner identification information. The apparatus and/or methods may also include using a processor to retrieve the data file and to instruct a transmission module to transmit the data file to a transaction processing network and to instruct the transmission module to initiate a transfer of funds from the platform to the rewards partner.

### FIELD OF TECHNOLOGY

Aspects of the disclosure relate to providing apparatus and methods for distributing information relating to transaction(s). In particular, the disclosure relates to apparatus and methods for distributing information between various parties in connection with transaction(s) between a customer and a vendor.

### BACKGROUND

In a typical debit card transaction, a customer (the “customer”) purchases from a merchant or service provider (“the merchant”) goods or services (“the goods”) using a debit card. The debit is extended to the customer by an issuing bank (the “issuer”). The merchant presents a debit to an acquiring bank (the “acquirer”). The acquirer pays the merchant for (and thus “acquires”) the goods on behalf of the customer. A transaction processing network in communication with the issuer and the acquirer settles the transaction between the issuer and the acquirer. The transaction processing network may collect transaction processing network fees from the issuer and the acquirer in connection with the settlement.

The issuer may impose upon the acquirer a fee for participating in the transaction. The fee may be referred to as “interchange.” Interchange may be a fixed fee for the transaction, a percentage of the transaction, or both. Interchange flows from the acquirer, through the transaction processing network, to the issuer. The issuer typically uses interchange to cover costs of acquiring debit card customers, servicing debit card accounts, providing incentives to retain customers, mitigating fraud and other expenses.

The acquirer may deduct a “transaction fee” from the amount that the acquirer pays the merchant in exchange for the goods. The transaction fee may cover the acquirer's transaction processing network fee, interchange, and other expenses. The acquirer may obtain a profit from the transaction fee.

With a co-branded rewards debit card, customers have the ability to earn rewards—e.g., miles, cash, points towards goods and/or services, etc. The customer can earn rewards, in some instances, every time the customer uses the debit card for a point-of-sale (“POS”) transaction. The issuer typically provides a data file to the rewards partner—i.e., the company that administers and/or provides the rewards points. The data file typically includes the amount of rewards to deposit into the customer's account.

The issuer typically funds the rewards program and pays the rewards partner directly for the rewards deposit into the customer's account.

It would be desirable to provide an electronic platform that supports a direct transaction between the transaction processing network and the rewards partner. The direct transaction may preferably occur at least partially independently of the participation of the issuer.

### SUMMARY OF THE INVENTION

Apparatus and methods for providing an electronic rewards points distribution platform. The apparatus and methods may involve a receiver module configured to receive a data file including transaction information for a customer. The data file may include transaction information representing transactions that occurred over a predetermined period of time. The receiver module may also be configured to receive transaction processing network information and rewards partner information. The apparatus and/or methods may also include a computer readable memory configured to store (1) the data file; (2) transaction processing network information; and (3) the rewards partner information. The apparatus and methods may also involve a processor module configured to instruct a transmission module to output the received transaction information to the identified transaction processing network information and/or the rewards partner information.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a prior art hybrid apparatus/process;

FIG. 3 shows an embodiment of a hybrid apparatus/process in accordance with the principles of the invention;

FIG. 4 shows another prior art hybrid apparatus/process;

FIG. 5 shows another embodiment of a hybrid apparatus/process in accordance with the principles of the invention;

FIG. 6 shows still another embodiment of a hybrid apparatus/process according to the invention;

FIG. 7 shows yet another embodiment of a hybrid apparatus/process according to the invention; and

FIG. 8 shows yet another embodiment of a hybrid apparatus/process according to the invention.

### DETAILED DESCRIPTION OF THE INVENTION

An electronic distribution platform for distributing rewards points is provided. The platform may include a receiver module configured to receive a data file. The data file may include transaction information representing a customer's transactions that occurred over a predetermined period of time or any other suitable data file that may be used to form a basis for awarding a customer rewards points. Such suitable data file may include a metric associated with customer behavior such as attendance at a program or other suitable metric. The receiver module can be further configured to receive transaction processing network information and rewards partner information.

The platform may further include a computer readable memory configured to store the data file; transaction processing network information; and the rewards partner information.

The platform may also include a processor module. The processor module may be configured to instruct a transmission module to output the data file to a transaction processing network identified in the transaction processing network information. The processor may also be configured to instruct the transmission module to initiate a transfer of funds from the platform to a rewards partner identified in the rewards partner information, wherein the amount of funds corresponds, at least in part, to the data file.

In some embodiments of the invention, the funds sent by the platform to the rewards partner correspond to the dollars spent by the consumer, and/or stored in the data file, based, at least in part, on a ratio of dollars spent to rewards points earned.

In certain embodiments of the invention, the processor may instruct the transmission module to output the received data file to the transaction processing network identified in the transaction processing network information and instructs the transfer of funds in a predetermined sequence. The processor may instruct the transmission module to output the received data file only after the processor instructs the transmission module to initiate the transfer of funds or in some other suitable sequence.

Certain embodiments of the invention may include where the receiver module is further configured to receive an instruction to transfer funds to the rewards partner. The amount of said funds may correspond, at least in part, to information in the data file.

The processor module may be further configured to notify the transaction processing network identified in the transaction processing network information regarding the transfer of funds to the rewards partner. In some embodiments, the processor module is further configured to notify, only after an amount of funds corresponding to, at least in part, the data file has been transferred from the transaction processing network to the electronic distribution platform, the transaction processing network regarding the transfer of funds to the rewards partner and/or the transfer of rewards points to the customer.

The invention may also include transaction information that represents a customer's transactions that occurred over a predetermined period of time and the transaction information may further include a total dollar amount of the customer's transactions.

The transaction information may include information representing a customer's transactions that occurred over a predetermined period of time and may further include a percentage of the total dollar amount of the customer's transactions. In some embodiments of the invention, the transaction information may include an amount of the customer's transactions over a predetermined threshold

The customer's transactions that occurred over a predetermined period of time may include transactions that form a selected portion of the customer's transactions. The portions of the transactions may be selected based, at least in part, on the category of the transactions or on any other suitable metric. For the purposes of this application, the category of the transactions may be understood to refer to the category of the vendor that provided the goods and/or services that formed part of the transactions. As such, the transactions may be spread across transactions for gasoline, transactions for food, transactions for entertainment, etc.

In certain embodiments of the invention, rewarding of the rewards points and/or other rewards may be conditioned on fulfillment by the customer of certain conditions such as timely payment of outstanding balances or other suitable conditions.

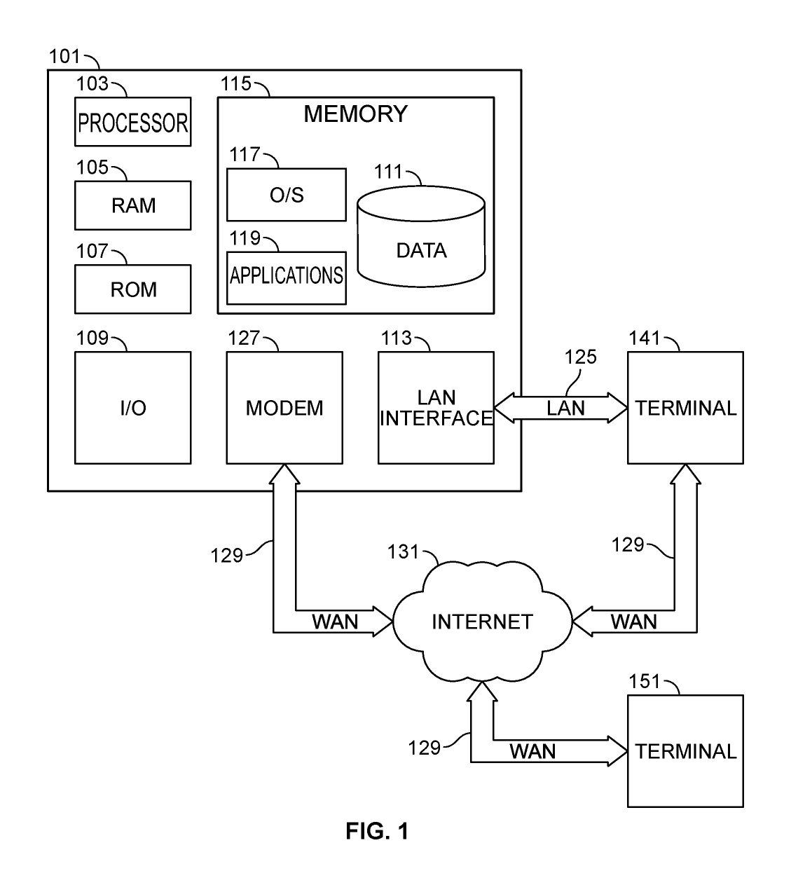

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125. Server 101 may include one or more receiver modules, server modules and processors that may be configured to receive transaction information, receive transaction information routing rules, receive transaction participant information, receive transaction service provider information, apply transaction information routing rules, generate transaction information routing information and perform any other suitable tasks related to routing transaction information.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, transaction information, merchant information, transaction fee information, rewards information, rewards factors and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Any information described above in connection with database 121, and any other suitable information, may be stored in memory 125.

One or more of applications 119 may include one or more algorithms that may be used to receive data files including transaction information, receive transaction participant information, receive transaction processing network information and perform any other suitable tasks related to routing transaction information.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

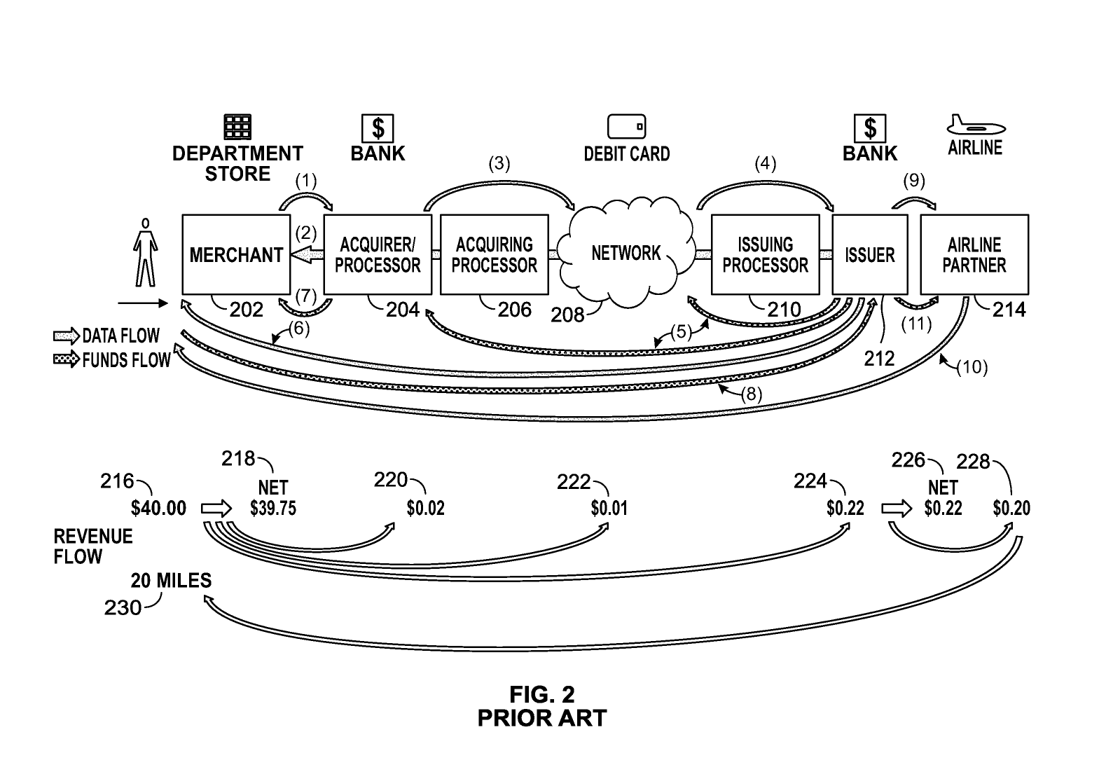

FIG. 2 shows a typical debit card transaction settlement flow. The flow involves transaction participants such as a customer, a merchant 202, and transaction service providers that are identified below.

| Transaction service providers, | |
|---|---|
| with respective roles | Functions |
| Merchant - exchange of | Submits Transactions |
| goods/services with customers | Interaction with Customer at |
| | POS |
| Acquirer - enables | Management of merchants |
| merchant acceptance of card | accounts |
| payments | Provides merchant POS equipment |
| | Merchant support and education |
| | Processing of card transaction |
| | from merchant to network |
| Network(s) - facilitates | Processing Clearing and |
| exchange of funds and data | settlement of transactions |
| | Sets and enforces rules and |
| | regulations (such as |
| | operational procedures and |
| | interchange) |
| | Promoting the network as a |
| | whole |
| | Development of new products |
| Issuer - Enables | Management and servicing of |
| customer use of payment device | cardholder accounts |
| | Acquisition and marketing |
| | Customer billing and collection |
| | Establishing credit limits and |
| | policies |
| | Design and manufacturing of |
| | cards |
| | Issuing and reissuing of cards |
| | Purchases miles from partner to |
| | reward customers |
| Airline Partner - Partners with | Receives payment from issue to |
| Issuer to provide miles to | purchase miles |
| customers when customers use | Posts miles to customer's |
| payment device | frequent flier number and/or |
| | deposits miles in customer's |
| | account |

At step 1, merchant 202 provides transaction information related to a proposed transaction between merchant 202 and a customer to a transaction acquirer/processor 204. At step 2, transaction acquirer/processor 204 may provide transaction authorization and clearance information to merchant 202. The transaction authorization and clearance information may include authorization for the transaction to proceed.

Following receipt of authorization for the transaction to proceed, merchant 202 may provide goods to a customer. The customer pays with a debit card.

At step 3, acquirer 204 transmits, via acquirer processor 206, the purchase information to the network 208. At step 4, network 208 transmits, via issuing processor 210, the purchase information to issuer 212.

At step 5, issuer 212 routes the purchase price amount through the transaction processing network 208 to the acquirer 204 by transmitting funds to network 208. Also, at step 6, issuer 212 sends statement to customer showing the purchase price due and requiring payment for transaction. At step 7, acquirer 204 settles with merchant 202. At step 8, customer pays issuer for transaction, along with interest and fees, if appropriate.

At step 9, issuer 212 transmits a data file to airline partner 214 (or any other suitable rewards partner). The data file indicates the amount of rewards due the customer for a predetermined period. Upon receipt of the data file, at step 10, airline partner 214 deposits the amount of rewards corresponding to the data file into the customer's account. Finally, at step 11, issuer 212 pays airline partner for the transferred rewards.

An exemplary revenue flow of such a prior art interchange transaction is shown at elements 216-230. The flow is for a $40.00 purchase. The flow is based on an assumption that two dollars of purchase obtains one mile of rewards.

The merchant nets $39.75 218 from such a $40.00 purchase 216. The acquirer nets two cents 220 from such a transaction. The network 208 nets one cent 222 from such a transaction. The issuer 212 nets two cents 224 from the transaction. The issuer 212 pays airline partner 214 20 cents 228 for each mile. The airline partner deposits 20 miles 230 into the customer's accounts.

TABLE 1
Net positions, by participant, based on revenue
flow (shown in FIG. 2).

| Participant | Net ($) |
|---|---|
| Customer | 2 Miles for 1 |
| | dollar spent |
| Rewards Partner | 20 cents per mile |
| Issuer | two cents |
| Acquirer | 2 cents |
| Transaction processing network | 1 cent |
| Merchant | −25 cents |

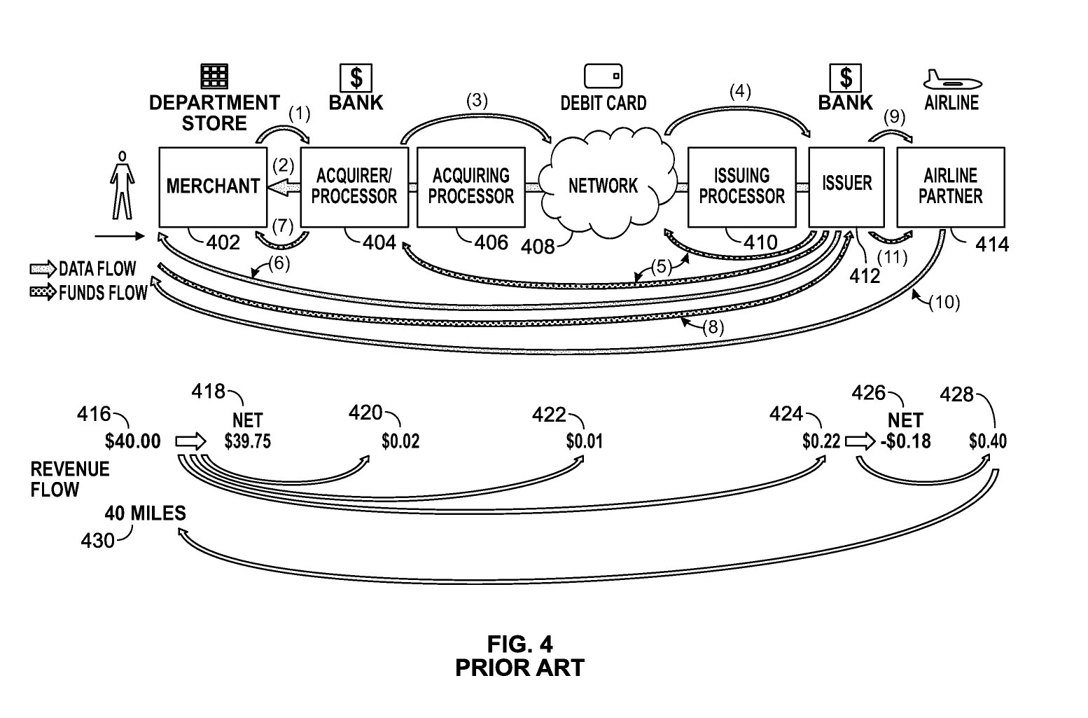

Another exemplary revenue flow of a conventional interchange transaction is shown in FIG. 4, at elements 416-430. It should be noted that elements 402-414, and steps 1-11 in FIG. 4 correspond to elements 202-214 and steps 1-11 shown in FIG. 2. For the sake of brevity, we have not repeated the description of elements 402-414, and steps 1-11, in FIG. 4.

The revenue flow shown in FIG. 4 is for a $40.00 purchase. The flow is based on an assumption that two dollars of purchase obtains two miles of rewards—i.e., each dollar spent earns one point of rewards.

The merchant nets $39.75 418 from such a $40.00 purchase 416. The acquirer nets two cents 420 from such a transaction. The network 408 nets one cent 422 from such a transaction. The issuer 212 nets two cents 224 from the transaction. The issuer 212 pays airline partner 214 0.20 cents 228 for each mile. The airline partner deposits 20 miles 230 into the customer's accounts.

TABLE 2
Net positions, by participant, based on revenue
flow (shown in FIG. 4).

| Participant | Net ($) |
|---|---|
| Customer | 1 Mile for 1 |
| | dollar spent |
| Rewards Partner | 40 cents per mile |
| Issuer | −18 cents |
| Acquirer | 2 cents |
| Transaction processing network | 1 cent |
| Merchant | −25 cents |

Transaction processing networks and transaction processing network services offered under the trademarks VISA, MASTERCARD, NYCE and PULSE are known. Transaction processing networks typically set interchange rates. Interchange rates often depend for each transaction processing network on merchant type and size, transaction processing method and other factors. Some transaction processing networks set rules that prohibit merchants from charging an incremental fee for debit card payments, establishing minimum or maximum purchase price amounts or refusing to accept selected cards.

The flow of transaction information between the transaction service providers is typically circumscribed by the relationships that are illustrated in FIG. 2. When relationships other than those shown in FIG. 2 are available, the other relationships may provide pathways for routing transaction information that may be used to execute one or more of the steps of a transaction between the merchant and the customer.

Apparatus and methods for providing a transaction information interface are provided. The apparatus and methods may involve: a receiver module configured to receive a data file including transaction information for a customer over a predetermined period of time, transaction processing network information and rewards partner information; and computer readable memory configured to store (1) the transaction information; (2) transaction processing network information; and (3) the rewards partner information. The apparatus and methods may also involve a processor module configured to output the received transaction information to the identified transaction processing network information and/or the rewards partner information.

In certain embodiments of the invention, the apparatus and methods may be configured to store the transaction information as a data file at a central location for access by the transaction processing network and/or the rewards partner. Alternatively, a system according to the invention may be configured to provide the transaction information as a data file directly to either the transaction processing network and/or the rewards partner.

The transaction information may include any information that is communicated, or would be appropriate to communicate, from one transaction participant to another transaction participant in connection with a group of transactions relating to a customer over a period of time.

A data file according to the invention may include all, substantially all or some portion of the purchasing information for a certain customer, or group of customers. The data file may be limited to purchases occurring on or after a start date and/or start time and on or before an end date and/or end time.

In some embodiments, the data file may be limited to transactions performed using a pre-determined payment instrument, such as a pre-determined debit card. It follows that the data file may be limited to include the customer's transaction information over a pre-determined amount of time using a pre-determined payment instrument.

The payment instrument may include a debit card and/or other form of payment instrument. Such other forms of payment instruments may include: a credit card, an instrument or device that includes a contactless chip, such as an ISO14443-compliant contactless chip, a cell phone, a personal data assistant, a transponder or any other suitable electronic purchasing devices. Purchasing instruments may store data in a magnetic strip, a bar code, a silicon chip or any other suitable data storage device or format. The merchant may provide a POS terminal that is configured to receive data from, provide data to, or exchange data with the purchasing instrument.

In some embodiments, the operation of a platform for distributing the information contained in the data file may be conditioned on a purchasing instrument that the customer selects for executing the transaction. The customer may select a card that is associated with an issuer. The customer may select a signature-based transaction. The customer may select a PIN-based transaction.

The selections may fulfill conditions necessary for application of a rewards distribution rule. For example, a customer may receive a certain number of points per dollar for a first type of purchasing instrument while the customer may receive a second number of points per dollar for a second type of purchasing instrument.

The transaction processing network information may include transaction processing network identification information.

The transaction information routing information may identify one or more second participants to whom the data file should be directly or indirectly routed in order to reward the customer.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

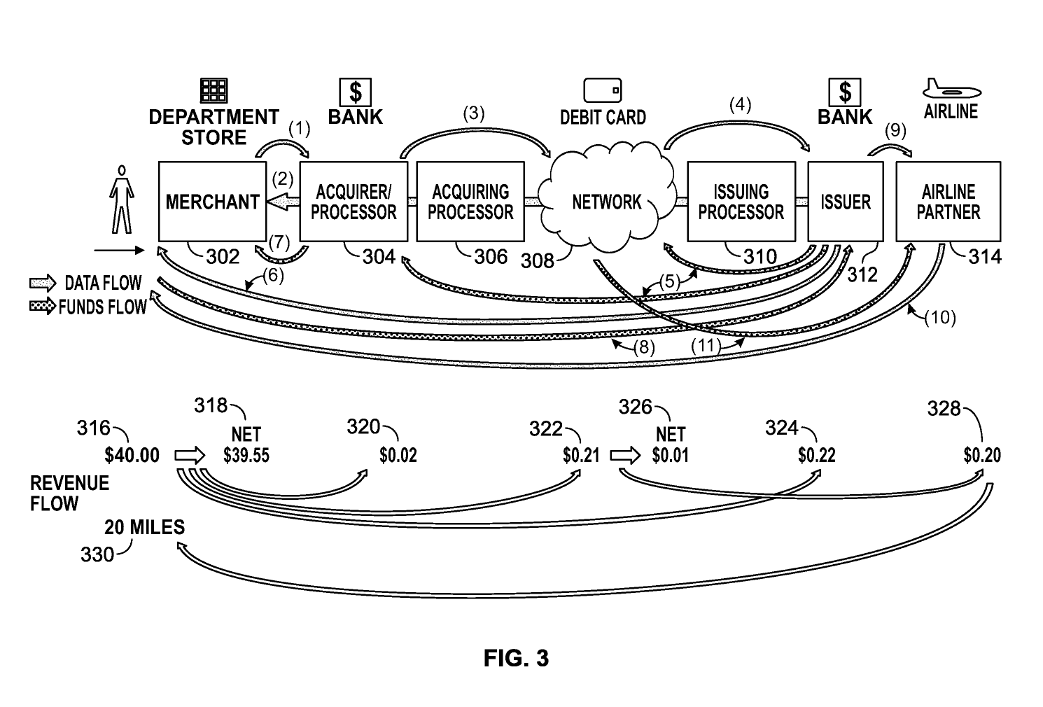

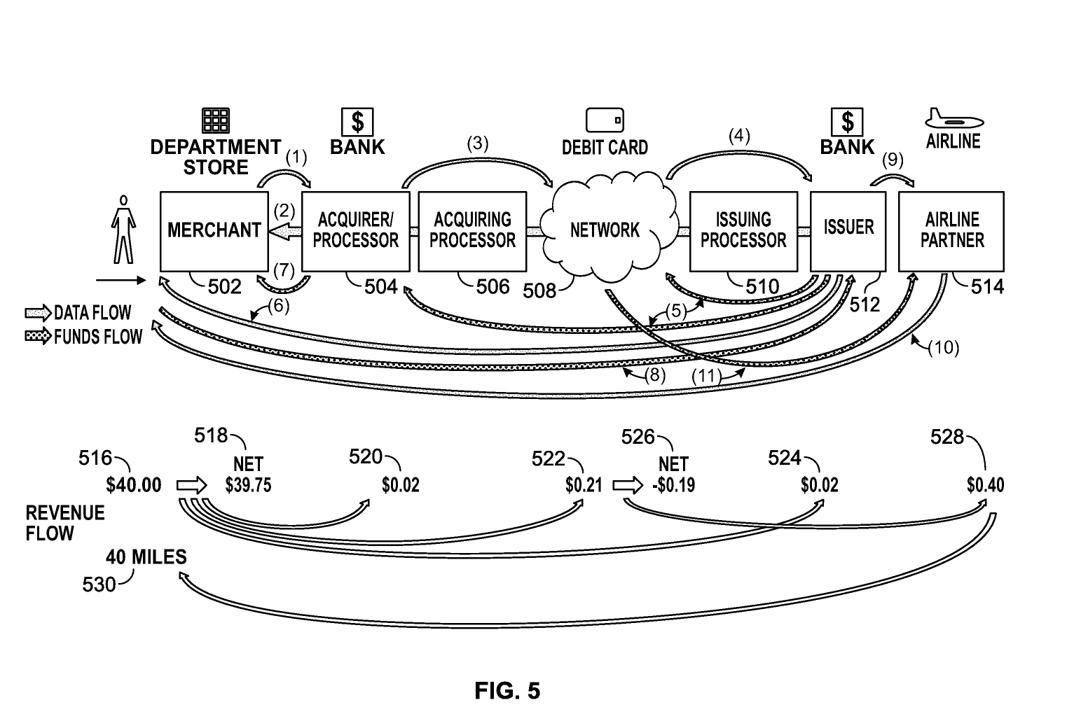

FIGS. 3 and 5 show exemplary embodiments of a hybrid system/process according to the invention. The main difference between FIGS. 2 and 4 and FIGS. 3 and 5, respectively, is that in FIGS. 2 and 4, at step 11, issuer 312 pays airline partner for the transferred rewards, whereas in FIGS. 3 and 5, networks 308/508, at step 11, pay airline partner for the transferred rewards. The remainder of the steps in FIGS. 3 and 5 correspond to the same steps in FIGS. 2 and 4, respectively.

FIGS. 3 and 5 show similar processes. The difference between FIGS. 3 and 5 is in the underlying assumptions, and the consequent revenue flows.

Specifically, FIG. 3 operates on the assumption that two dollars of purchase obtains one mile of rewards; whereas FIG. 5 operates on the assumption that one dollar of purchase obtains one mile of rewards.

An exemplary revenue flow of such an interchange transaction according to the transaction is shown at elements 316-330. The flow is for a $40.00 purchase. Again, the flow in FIG. 3 is based on an assumption that two dollars of purchase obtains one mile of rewards.

In FIG. 3, the merchant 302 again nets $39.75 318 from such a $40.00 purchase 316. The acquirer 304 nets two cents 320 from such a transaction. The network 308 nets one cent 322 from such a transaction. The issuer 312 nets two cents 324 from the transaction. Network 308 now pays airline partner 314 0.20 cents 328 for each mile. The airline partner deposits 20 miles 330 into the customer's accounts.

TABLE 3
Net positions, by participant, based on revenue
flow (shown in FIG. 3, same as in FIG. 2).

| Participant | Net ($) |
|---|---|
| Customer | 2 Miles for 1 |
| | dollar spent |
| Rewards Partner | 20 cents per mile |
| Issuer | two cents |
| Acquirer | 2 cents |
| Transaction processing network | 1 cent |
| Merchant | −25 cents |

Another exemplary revenue flow of an interchange transaction according to the transaction is shown in FIG. 5 at elements 516-530. The flow is for a $40.00 purchase. The flow in FIG. 5 is based on an assumption that one dollar of purchase obtains one mile of rewards.

In FIG. 5, the merchant 502 also nets $39.75 518 from such a $40.00 purchase 516. The acquirer 504 nets two cents 520 from such a transaction. The network 508 nets negative −19 cents 522 from such a transaction. The issuer 512 nets two cents 524 from the transaction. Network 508 now pays airline partner 514 40 cents 528 for each mile. The airline partner deposits 40 miles 330 into the customer's accounts.

TABLE 4
Net positions, by participant, based on
revenue flow (shown in FIG. 5).

| Participant | Net ($) |
|---|---|
| Customer | 1 Mile for 1 |
| | dollar spent |
| Rewards Partner | 40 cents per mile |
| Issuer | 2 cents |
| Acquirer | 2 cents |
| Transaction processing network | −19 cents |
| Merchant | −25 cents |

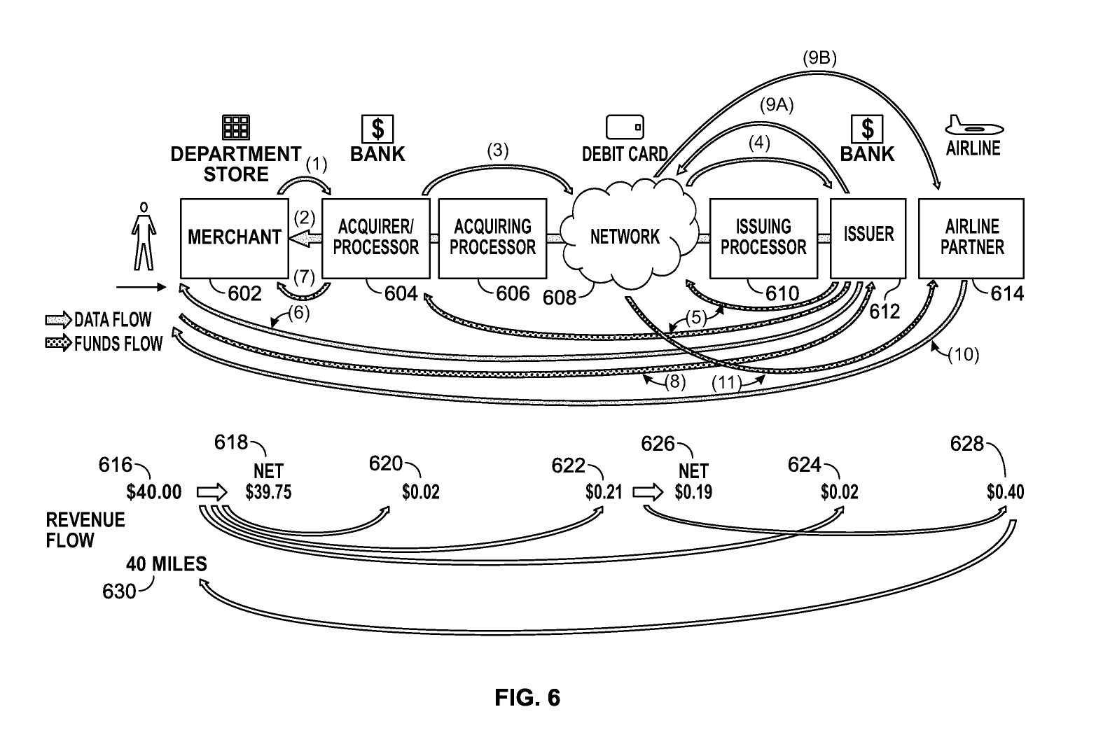

FIG. 6 shows yet another embodiment of a hybrid apparatus/process according to the invention. Much of FIG. 6 is shown and described with respect to FIG. 5. One main difference between FIG. 6 and the preceding FIG. 5 is that step 9, which transferred a data file, preferably including the amount of rewards to deposit into the customer's account, from issuer 512 to airline partner 514, has now been redirected such that step 9A shows issuer 612 transferring a data file to network 608. Thereafter, network 608 can transfer the data file at step 9B to airline partner 614. Furthermore, network 608 can transfer rewards miles at step 11 to airline partner 614.

The revenue flow for FIG. 6 (not shown) may, in certain embodiments, be preferably the same, or different, from what is shown in FIG. 5.

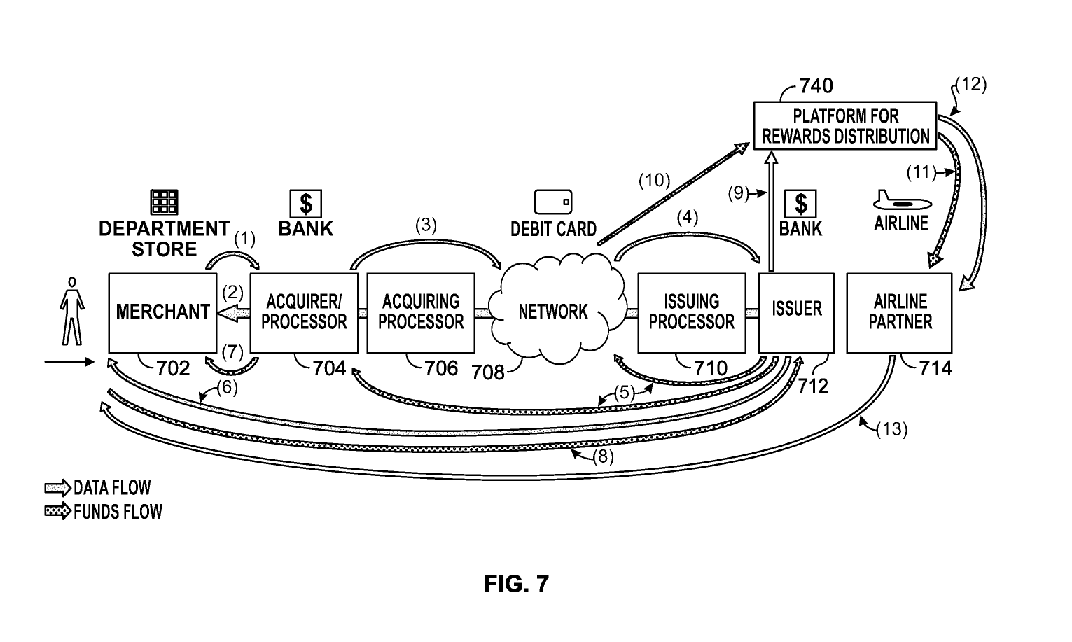

FIG. 7 shows still another embodiment of a hybrid apparatus/process according to the invention. FIG. 7 preferably includes an electronic platform 740 for rewards distributions. In one preferable embodiment of implementation of the platform, step 9 shows transferring the data file, preferably including the amount of rewards to deposit into the customer's account, from issuer 712 to platform 740.

In addition, network 708 preferably transfers funds to platform 740 at step 10. The transfer of funds may preferably be in response to a communication (not shown), either from issuer 712 and/or from platform 740, indicating the amount of funds necessary to cover the rewards distribution. In some embodiments of platform and/or the hybrid process/apparatus shown in FIG. 7, the funds may still be transferred directly from network 708 to airline partner 714, such as is shown in FIGS. 5 and 6 at step 11.

Following receipt of funds at platform 740 from network 708, or following receipt of some other indication from the system that platform should transfer the data file and/or funds to airline partner 714, platform 740 proceeds, at steps 11 and 12, to transfer the funds and the data file, respectively, to airline partner 714. Once airline partner 714 receives, at steps 11 and 12, the data file and the funds, airline partner 714 can preferably deposit, at step 13, the rewards miles in the account of the customer.

One advantage of platform 740 is that, in certain embodiments, platform 740 can coordinate the delivery of the data file with the funds in a predetermined sequence, and/or at predetermined times, to airline partner 714 or any of the transmitted items and/or information to any other suitable party. Thus, platform 740 may act as a gatekeeper for delivery of funds to airline partner 714. In one exemplary embodiment, airline partner 714 may be required to electronically notify either issuer 712, network 708 and/or platform 740 when the miles have been deposited into the customer's account. Following receipt of the notification from airline partner 514, then, and preferably only then, may platform 740 release funds to airline partner 614.

Furthermore, platform 740 may also serve a reporting function—i.e., platform 740 may preferably notify issuer 714 and/or network 708 regarding transmission of miles to customer, funds to airline partner 740 or transfer of any other relevant information and/or funds between any of the relevant parties.

In addition, platform 740 may preferably include rules for notification. Such rules may be stored in a database. The rules may preferably indicate the order by which information is disseminated, if at all. For example, the rules may dictate that the platform may notify the issuer and/or the network regarding transmission of miles to the customer only after the airline partner has been funded. Alternatively, the rules may dictate that the platform may notify the customer regarding the deposit of the miles only after the airline partner has been funded.

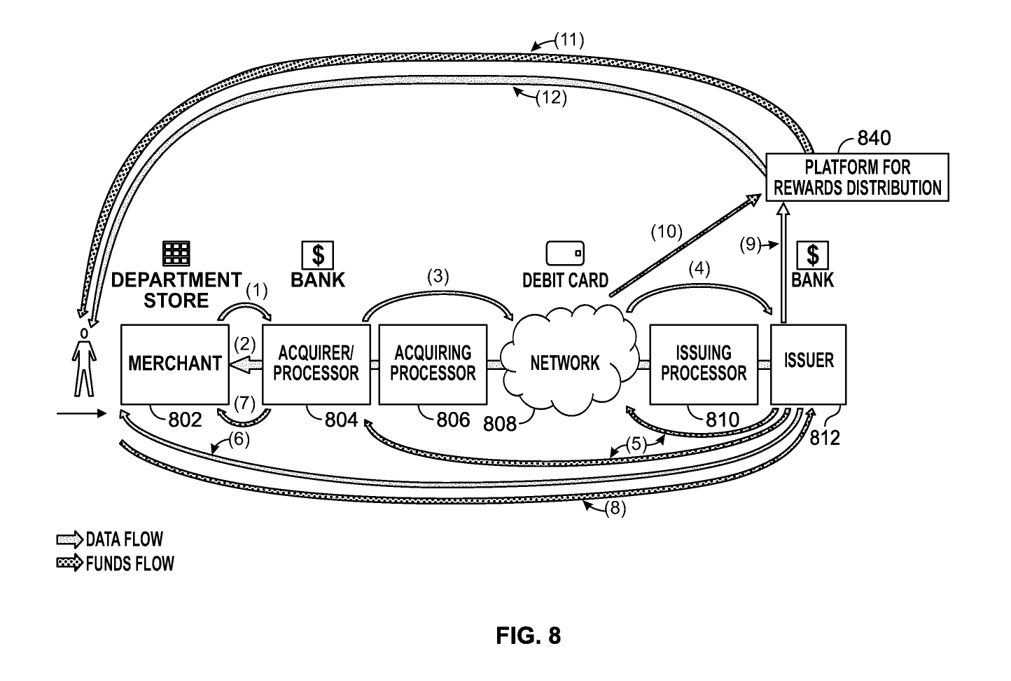

FIG. 8 shows yet another embodiment of a hybrid apparatus/process according to the invention. FIG. 8 shows an embodiment without a rewards partner—e.g., an airline partner. Step 8 includes steps similar to FIG. 7, but for the removal of airline partner 714 and step 13, as well as the redirection of steps 11 and 12, as will be described in more detail below.

In such an embodiment, FIG. 8 preferably includes electronic platform 840 for cash rewards distributions, or other suitable, directly-deposited, rewards. In one preferable embodiment of implementation of platform 840, steps 11 and 12 show transferring the data file, and funds associated therewith, directly to the customer. Such a transfer may preferably include directly depositing funds into a customer's checking account, savings account or other suitable Direct Deposit Account (“DDA”).

It should be further noted with respect to FIG. 8 that step 10 continues to show that funds are being provided to platform 840 by network 808, similar to step 10 shown in FIG. 7.

Any suitable rule relating to information dissemination and/or funds disbursement may be implemented and should be considered to be within the scope of this application with respect to any of the above-described embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for implementing one or more transaction information interfaces have been provided. Persons skilled in the art will appreciate that the present invention can be practiced by other than the described embodiments, which are presented for purposes of illustration rather than of limitation. The present invention is limited only by the claims that follow.

What is claimed is:

1. An electronic distribution platform for distributing rewards points, the platform comprising:
a receiver module configured to receive a data file, wherein the data file includes transaction information representing a customer's transactions that occurred over a predetermined period of time, and the receiver module is further configured to receive transaction processing network information and rewards partner information;
computer readable memory configured to store:
(1) the data file;
(2) transaction processing network information; and
(3) the rewards partner information; and
a processor module configured to instruct a transmission module to output the received data file to a transaction processing network identified in the transaction processing network information and to instruct the transmission module to initiate a transfer of funds from the platform to a rewards partner identified in the rewards partner information, wherein the amount of funds corresponds, at least in part, to the data file.

2. The apparatus of claim 1 wherein the correspondence between the funds and the data file is based on a predetermined rule.

3. The apparatus of claim 1 wherein a sequence by which the processor instructs the transmission module to output the received data file to the transaction processing network identified in the transaction processing network information and instructs the transfer of funds is a predetermined sequence.

4. The apparatus of claim 1 wherein, the receiver module is further configured to receive an instruction to transfer funds to the rewards partner, wherein the amount of said funds corresponds, at least in part, to the data file.

5. The apparatus of claim 1 wherein the processor module is further configured to notify the transaction processing network identified in the transaction processing network information regarding the transfer of funds to the rewards partner.

6. The apparatus of claim 1 wherein the processor module is further configured to notify, only after an amount of funds corresponding to, at least in part, the data file has been transferred from the transaction processing network to the electronic distribution platform, the transaction processing network regarding the transfer of funds to the rewards partner and/or the transfer of rewards points to the customer.

7. The apparatus of claim 1 wherein, the correspondence between the funds and the data file is based on a predetermined rule, wherein the predetermined rule is based, at least in part, on a ratio of dollars spent to rewards points earned.

8. The apparatus of claim 1 wherein the transaction information represents a customer's transactions that occurred over a predetermined period of time and further comprises a total dollar amount of the customer's transactions.

9. The apparatus of claim 1 wherein the transaction information representing a customer's transactions that occurred over a predetermined period of time further comprises a total dollar amount of the customer's transactions.

10. The apparatus of claim 1 wherein the transaction information representing a customer's transactions that occurred over a predetermined period of time further comprises a total dollar amount of the customer's transactions over a predetermined threshold.

11. The apparatus of claim 1 wherein the transaction information representing a customer's transactions that occurred over a predetermined period of time further comprises a percentage of the total dollar amount of the customer's transactions.

12. The apparatus of claim 1 wherein the transaction information representing a customer's transactions that occurred over a predetermined period of time comprises transactions that form a selected portion of the customer's transactions, wherein the transactions are selected based, at least in part, on the category of the transactions.

13. One or more computer-readable media storing computer-executable instructions which, when executed by a processor on a computer system, perform a method for distributing rewards points, the method comprising:
using a receiver module to receive a data file, wherein the data file includes transaction information representing a customer's transactions that occurred over a predetermined period of time, and to receive transaction processing network identification information and rewards partner identification information;
storing in computer readable memory:
(1) the data file;
(2) transaction processing network identification information; and
(3) the rewards partner identification information; and
using a processor to retrieve from the computer readable memory the data file and to instruct a transmission module to transmit the data file to a transaction processing network identified in the transaction processing network identification information and to instruct the transmission module to initiate a transfer of funds from the platform to the rewards partner identified in the rewards partner identification information.

14. The media of claim 13 wherein, in the method, the correspondence between the funds and the data file is based on a predetermined rule, said rule being based, at least in part, on a ratio of dollars spent to rewards points distributed.

15. The media of claim 13 wherein, in the method, a sequence by which the processor instructs the transmission module to output the received data file to the transaction processing network and initiates the transfer of funds is a predetermined sequence.

16. The media of claim 13 wherein, in the method, the receiving further comprises receiving an instruction to transfer funds to the rewards partner, wherein the amount of said funds corresponds, at least in part to the data file.

17. The media of claim 13 wherein, in the method, the using a processor further comprises using a processor to notify the transaction processing network identified in the transaction processing network identification information regarding the transfer of funds to the rewards partner.

18. The media of claim 13 wherein, in the method, the using a processor further comprises using a processor to notify, only after an amount of funds corresponding to the data file has been transferred from the transaction processing network to the electronic distribution platform, the transaction processing network identified in the transaction processing network identification information regarding the transfer of funds to the rewards partner.

19. The media of claim 13 wherein, in the method, the transaction information comprises information relating to a customer's transactions that occurred over a predetermined period of time and further comprises a total dollar amount of the customer's transactions.

20. The media of claim 13 wherein, in the method, the transaction information comprising a customer's transactions that occurred over a predetermined period of time further comprises a total dollar amount of the customer's transactions.

21. The media of claim 13 wherein, in the method, the transaction information representing a customer's transactions that occurred over a predetermined period of time further comprises a total dollar amount of the customer's transactions.

22. The media of claim 13 wherein, in the method, the transaction information representing a customer's transactions that occurred over a predetermined period of time further comprises a percentage of the total dollar amount of the customer's transactions.

23. The media of claim 13 wherein, in the method, the transaction information comprising a customer's transactions that occurred over a predetermined period of time comprises transactions that form a selected portion of the customer's transactions, wherein the transactions are selected based, at least in part on the vendor category of the transactions.
